(19) United States
(12) Patent Application Publication
(10) Pub. No.: US 2021/0331403 A1
(43) Pub. Date: Oct. 28, 2021

(54) SEGMENTING OBJECT MODEL DATA AT FIRST AND SECOND RESOLUTIONS

(71) Applicant: HEWLETT-PACKARD DEVELOPMENT COMPANY, L.P., Spring, TX (US)

(72) Inventors: David Ramirez Muela, Sant Cugat del Valles (ES); Manuel Freire Garcia, Sant Cugat del Valles (ES); Lluis Abello Rosello, Sant Cugat del Valles (ES); Sergio Puigardeu Aramendia, Sant Cugat del Valles (ES)

(21) Appl. No.: 16/605,585

(22) PCT Filed: Apr. 27, 2018
(86) PCT No.: PCT/US2018/029879

§ 371 Date: Oct. 16, 2019

(51) Int. Cl. B29C 64/393; B29C 64/118; G06T 7/10; G06F 30/10; B33Y 10/00; B33Y 50/02

(52) U.S. Cl. CPC B29C 64/393; B29C 64/118; G06T 7/10; G06F 2113/10; B33Y 10/00; B33Y 50/02; G06F 30/10

(57) ABSTRACT

An example method includes acquiring a model of an object to be generated in three-dimensional object generation which is segmented into a plurality of object model sub-volumes, each sub-volume representing a region of the object which is individually addressable in object generation. Object model sub-volumes within a first depth of an object model surface are defined at a first resolution and object model sub-volumes beyond the first depth are defined at a second resolution, and the first resolution is a higher resolution than the second resolution. An object generation model is applied to the object model to determine at least one predicted dimensional deviation of the object in object generation. A geometric adjustment to the segmented object model may be determined to compensate for the predicted dimensional deviation by adding and/or removing at least one object model sub-volume defined at the first resolution.

### BACKGROUND

Additive manufacturing techniques may generate a three-dimensional object through the solidification of a build material, for example on a layer-by-layer basis. In examples of such techniques, build material may be supplied in a layer-wise manner and the solidification method includes heating the layers of build material to cause melting in selected sub-volumes. In other techniques, chemical solidification methods may be used.

### BRIEF DESCRIPTION OF DRAWINGS

Non-limiting examples will now be described with reference to the accompanying drawings, in which:

FIG. 1 is a flowchart of an example method of processing data for use in additive manufacturing;

FIG. 2 is a schematic example of an object segmented into sub-volumes of different sizes;

FIG. 3 is a flowchart of another example method of processing data for use in additive manufacturing;

FIG. 4 is a flowchart of an example method of generating an object;

FIG. 5 is a simplified schematic drawing of an example of apparatus for processing data for additive manufacturing;

FIG. 6 is a simplified schematic drawing of an example apparatus for additive manufacturing; and

FIG. 7 is a simplified schematic drawing of an example machine readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially known as V1Q60Q “HP fusing agent” available from HP Inc. In one example such a fusing agent may comprise an infra-red light absorber. In one example such a fusing agent may comprise a near infra-red light absorber. In one example such a fusing agent may comprise a visible light absorber. In one example such a fusing agent may comprise a UV light absorber. Examples of print agents comprising visible light enhancers are dye based colored ink and pigment based colored ink, such as inks commercially known as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, the detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

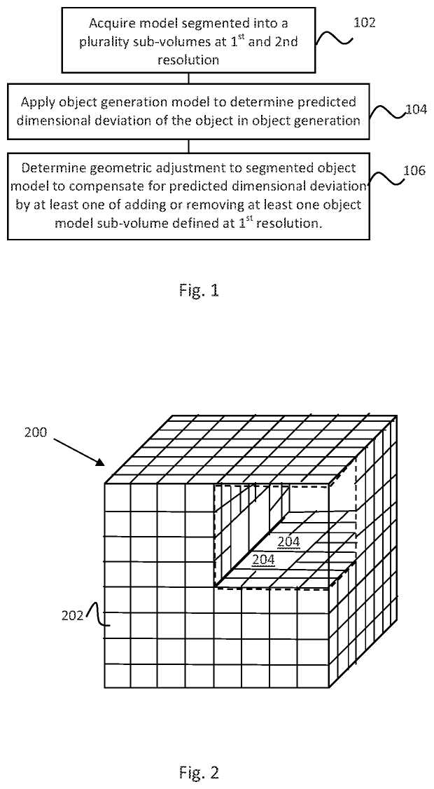

FIG. 1 is an example of a method, which may comprise a computer implemented method, comprising, in block 102, acquiring a model of at least part of object (which includes a portion of a model) to be generated in three-dimensional object generation which is segmented into a plurality of sub-volumes at a first and a second resolution. In some examples, block 102 may comprise segmenting an object model. In other examples, block 102 may comprise acquiring the model from a memory, over a network or the like.

Block 103 may comprise segmenting an object model which comprises data representing at least a portion of an object to be generated by an additive manufacturing apparatus by fusing a build material. The object model data may for example comprise a Computer Aided Design (CAD) model, and/or may for example be a STereoLithographic (STL) data file. In some examples, the model may be defined in terms of sub-volumes at one resolution and block 102 may comprise dividing or combining sub-volumes in at least an object portion.

In this example, each sub-volume represents a region of the object which is individually addressable in object generation. In some examples herein, the sub-volumes may be referred to as voxels, i.e. three-dimensional pixels, wherein each voxel occupies or represents a discrete volume. In some examples of additive manufacturing, three-dimensional space may be characterised in terms of such voxels. In some examples, the voxels are determined bearing in mind the print resolution of an object generation apparatus, such that each voxel represents a region which may be uniquely addressed when applying print agents, and therefore the properties of one voxel may vary from those of neighbouring voxels. In other words, a voxel may correspond to a volume which can be individually addressed by an object generation apparatus (which may be a particular object generation apparatus, or a class of object generation apparatus, or the like) such that the properties thereof can be determined at least substantially independently of the properties of other voxels. For example, the ‘height’ of a voxel may correspond to the height of a layer of build material. In some examples, the resolution of an object generation apparatus may exceed the resolution of a voxel. In general, the voxels of an object model may each have the same shape (for example, cuboid or tetrahedral), but they may in principle differ in shape. In some examples, voxels are cuboids, for example cubes based on the height of a layer of build material. In some examples, in processing data representing an object, each voxel may be associated with properties, and/or then to object generation instructions, which apply to the voxel as a whole.

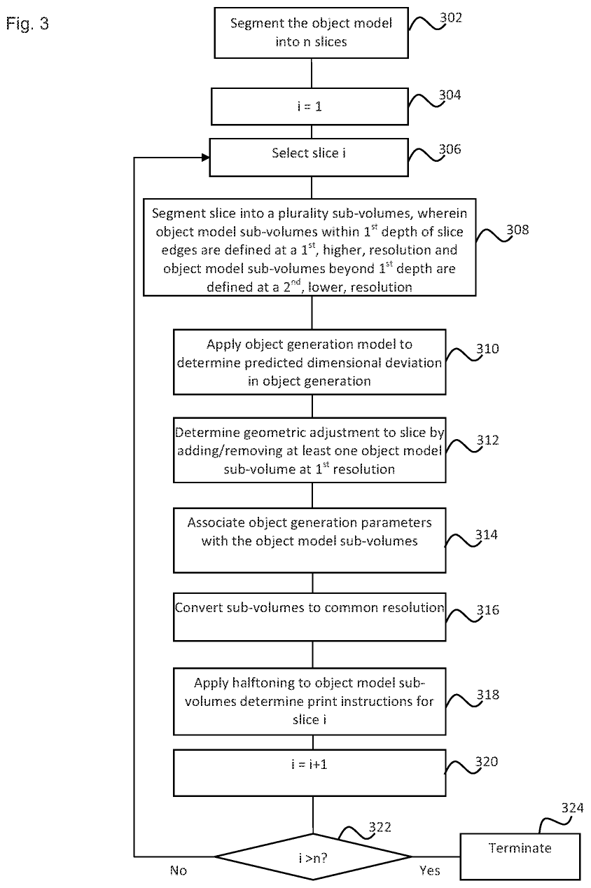

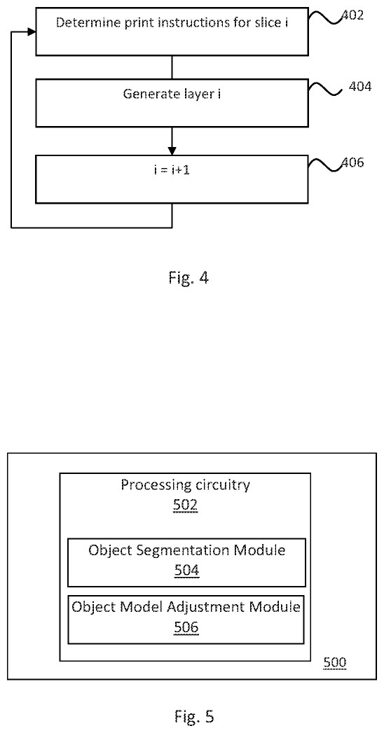

In some examples, a segmentation may be carried out on a slice by slice basis, for example as discussed in greater detail in relation to FIGS. 3 and 4 below. In some examples, the slice may be a slice of a virtual build volume modelling an intended ‘real’ build volume, and may comprise slices taken from more than one object models. In some examples, the slices may be one voxel thick.

In particular, in block 102, the object model sub-volumes within a first depth (or distance) of an object model surface are defined at a first resolution and object model sub-volumes beyond the first depth are defined at a second resolution, and the first resolution is a higher resolution than the second resolution. In other words, a core is defined at the second, coarser, resolution (the object model sub-volumes are larger) and a ‘shell’ of the object is defined at the first, finer, resolution (the object model sub-volumes are smaller).

The first depth may be predetermined, or may be determined based on thermal characteristics. For example, larger objects and object portions may be associated with a greater first depth (e.g. 10-20 sub-volumes/voxels) than smaller objects/object portions (e.g. 1-10 sub-volumes/voxels). This is because, as further explained below, larger objects may generally suffer greater dimensional deviations in object generation. In general therefore, the method may comprise determining the first depth based on a predicted thermal mass of the object during object generation. In some examples, a larger thermal mass is associated with a larger first depth.

While in some examples the first depth may be consistent over the whole object slice, or whole object, for example based on a predicted thermal mass of the object/slice, in other examples, the first depth may vary over the surface of an object/perimeter of a slice. In such examples, determining the first depth may comprise analysing object model data representing at least a portion of an object to be generated by an additive manufacturing apparatus by fusing build material, to determine a plurality of predicted temperatures of object generation, each predicted temperature corresponding to a different location; and determining, using at least one processor, the first depth volume, wherein a local value of the first depth is determined based on a local predicted temperature.

In some examples, determining the predicted temperature values of object generation may comprise determining a heat map for at least a portion of the object during object generation. This may be based on an intended distribution of print agents, a choice of intended print agents and/or intended operational temperatures (such as bed warming temperatures) and the like.

In some examples, a first depth may be locally determined based on the temperature of a surface voxel. The temperature of the voxel may be an average temperature, for example corresponding to the temperature of a pixel of a heat map (which may correspond to a voxel on a many to one, one to one, or one to many basis), or may be a temperature predicted for a point within the voxel, or determined in some other way. For example, an object slice perimeter may be divided into lengths, and the average temperature of each length (in some examples, to a threshold depth) may provide a local temperature based on which the local value of the first depth may be determined. In some examples, the perimeter may be divided into predicted temperature ‘bins’ based on a predicted temperature falling within a temperature range, and this may define a local region to which a local first depth value may be applied. In some examples, a first depth value proximate a first location of the object (which may be a surface location) is based on a first predicted object generation temperature and a first depth value proximate a second location is based on a second predicted object generation temperature.

The first depth may be a depth from all surfaces, including internal surfaces (e.g. the bowl of a cup, or the interior surface of a hollow object, or the like). The first depth may be different in different object portions.

Block 104 comprises applying an object generation model to the object model to determine at least one predicted dimensional deviation of the object in object generation.

In some examples, such dimensional deviation(s) may be due to thermal effects, in particular in 3D printing processes that use heat to melt/fuse build material. As further set out below, the temperatures achieved in object generation in such examples may be associated with the solid volume of object features, and also the proximity of object features to other object features. In addition, the temperature achieved may be affected by at least one print agent applied to the build material. Therefore, in some examples, applying the object generation model in block 104 comprises applying a thermal object generation model. While in this example, block 104 follows block 102, implying that the object generation model is applied to the segmented object model, this need not be the case in all examples, and the object generation model may be applied to the un-segmented object model.

Block 106 comprises determining a geometric adjustment to the segmented object model to compensate for the predicted dimensional deviation by at least one of adding or removing at least one object model sub-volume defined at the first resolution. For example, if a positive deviation, i.e. a ‘bulge’, in the object is predicted, a sub-volume (e.g. a voxel) may be removed from the model data. Positive deviations can be caused by large thermal masses, or by the close proximity of smaller parts that act like a larger consolidated thermal mass. If however a negative deviation is predicted, a sub-volume (a voxel) may be added. For example, such a negative deviation may be seen when internal dimensions (e.g. holes, gaps) are expected to be smaller than intended. In other examples, at least one sub-volume may be added to a feature which is otherwise ‘too small’ to fuse. For example, the geometric adjustment may be such that, when an object is generated using the modification data, the temperature of the feature will be (or is predicted to be) at least the fusing temperature. This may comprise increasing the size of a feature.

To consider this in a little more detail, in some additive manufacturing techniques, object data may comprise features of variable size. Certain features may be relatively small, or relatively small within a layer. There may be a minimum feature size which can be generated by an apparatus, for example a finite resolution in relation to the accuracy with which build material and/or print agents may be placed. Some techniques allow for accurate placement of print agent on a build material, for example by using print heads operated according to inkjet principles of two dimensional printing to apply print agents, which in some examples may be controlled to apply print agents with a control data resolution of around 600 dpi. This theoretically means that features as small as 42 microns could be generated. However, as noted above, energy is applied (for example using heat lamps, for example halogen or other IR sources) to cause the build materials to fuse, and such small areas of fusing agent-treated build material may not absorb enough energy to reach the fusing temperature of the build material. Thus, in practise, in some examples, the minimum printable feature size may be determined not by the resolution of the object generation apparatus but by the temperature that such a feature can reach during the fusing process.

In some examples, sub-volumes may be removed (or eroded) in at least one object model sub-volume to prevent different object surfaces from fusing together, or to ensure intended cavities remain open, to compensate for object ‘growth’ due to build material which is not intended to fuse fusing and/or adhering to the object surfaces, or the like. It may be noted that, in block 106, the adjustments are made to sub-volumes defined at the first resolution, i.e. the finer resolution. This means that the individually incremental changes made may be smaller than if the adjustments were made using sub-volumes defined at the coarser second resolution. However, if smaller sub-volumes are defined for the whole object, at least one additional data processing stage, in a particular example, the relatively resource-intensive process of assigning object generation parameters to sub-volumes (described in greater detail below), may become large. In particular examples, it may be intended to process the data to be used in generating a layer as a previous layer is actually being manufactured. In such examples, it may be intended that the data processing time for a layer is at least not substantially longer than a layer generation time. In such examples, increasing the overall number of sub-volumes too significantly may result in a data processing time which cannot be achieved in a layer build time. Therefore, the method described above provides smaller sub-volumes to a first depth (the ‘shell’ of the object model), in which adjustments may be made, and larger sub-volumes in the ‘core’ of the object, which is unlikely to be subject to geometric adjustments.

To consider a particular example for context, there may be a predetermined dimensional tolerance of, for example, around 200 microns. In other words, it is intended that, on manufacture, the dimensions of the object depart by no more than 200 microns from the intended dimensions.

In one example, a print addressable sub-volume may be a volume with a cross section of 42×42 micron (which corresponds to a print control resolution of 600 dots per inch (dpi)). Such a volume may be appropriate given processing resources available to generate control data. However, in practice, adjustments are often carried out bilaterally (e.g. both sides of a feature may be eroded by one sub-volume, or have a sub-volume added thereto for the sake of symmetry). Therefore, making an adjustment accounts for 84 microns, or 42%, of the tolerance. However, by applying the methods set out above, if the outer sub-volumes were instead 21 microns in cross section (which corresponds to a print control resolution of 1200 dpi), this reduces the adjustment increments to 42 microns.

In some examples, block 104 and 106 may be carried out iteratively over a number of cycles until a predicted dimensional deviation is adequately compensated for.

FIG. 2 shows an example of an object, in this example a cube 200, comprising a cut-through view to show portions of the interior. The outer shell of the cube 200 is defined at a first resolution to a depth of two sub-volumes 202 (small voxels) and an inner core is defined by volumes at a second resolution 204, which are relatively large. Although in the Figure, for the sake of illustration, the region defined at the first resolution is a significant proportion of the object 200, in practice, it may be a relatively small proportion of the volume, providing a ‘skin’ of the object 200.

While in the example of FIG. 2, all of sub-volumes are shown as cubes, this may not be the case. In some examples, the height of the sub-volumes may be the same for all resolutions (e.g. corresponding to a layer or slice height), and the cross sectional area may vary between the different resolutions.

FIG. 3 is another example of a method, which may comprise a computer implemented method. In this example, data processing is carried out on the model of the object on a slice by slice basis and block 302 comprises segmenting the object model into a plurality of object model slices, in this example n slices, where n is an integer. In some examples, these slices have a height corresponding to a layer of build material. An index i is then set to 1 in block 304, and in block 306, slice i is selected. The first selected slice may correspond to the layer of the object to be generated first. While in this example, a single object is considered, in other examples, a plurality of objects may be generated as a batch in a single build volume. In such examples, a slice may be a slice of a virtual build volume (i.e. a model of the build volume), and may comprise slices of more than one object.

Block 308 comprises segmenting the slice into a plurality of sub-volumes, wherein object model sub-volumes within a first depth of an object model surface are defined at a first, higher, resolution and object model sub-volumes beyond the first depth are defined at a second, lower, resolution. This resolution may be a cross sectional resolution, as the height of the sub-volumes may be consistent, e.g. comprising the slice height.

The resolutions in this example correspond to print control resolutions of 600 dpi in the ‘core’ and 1200 dpi in the ‘shell’. In this example, the depth is defined in two dimensions, i.e. a distance from the slice edges, but it could also be XYZ distance to any given surface.

Blocks 310 and 312 are then carried out for the slice as outlined above in relation to blocks 104 and 106 respectively.

Block 314 comprises associating object generation parameters with the object model sub-volumes. For example, this may comprise setting an amount of fusing agent and/or detailing agent to apply to each sub-volume. This may be carried out outside the object (for example, a detailing agent may be used to cool the build material which is not intended to fuse, for example to provide a sharply defined edge to the object). This process is relatively process intensive and may involve considering thermal interactions in the object as it is generated. In one example, this process involves 2D convolutions of a relatively large kernel over a very large ‘image’ of the slice (For example, this may be tens of megapixels, for example on the order of 70 or 80 megapixels). Several auxiliary planes may be allocated in memory to perform the operation, and total calculation times can exceed 5 seconds.

Block 316 comprises converting the object model sub-volumes associated with object generation parameters to a common resolution. Converting the object model sub-volumes associated with object generation parameters to a common resolution may for example comprise dividing at least one object model sub-volume into a plurality of smaller sub-volumes and associating object generation parameters of sub-volume with each smaller sub-volume. In other words, the object model sub-volumes may be ‘up-scaled’ or the data associated with one sub-volume may be replicated to a plurality of smaller sub-volumes. A single sub-volume in a slice may be divided into four, for example, to double the resolution at the slice cross section. This processing could for example be applied to the core at 600 dpi in this example such that both the core and shell are defined at 1200 dpi.

Converting the object model sub-volumes associated with object generation parameters to a common resolution may comprise combining a plurality of object model sub-volumes and the associated object generation parameters of the combined sub-volumes into a combined object model sub-volume associated with combined object generation parameters. In other words, the object model sub-volumes may be ‘down-scaled’. For example, four sub-volumes in a slice may be combined into one single sub-volume. The object generation parameters may be combined as an average, or interpolation, of the generation parameters. In some examples, rounding may be applied to the nearest achievable increment for an intended print apparatus (e.g. to the nearest whole number of drops of a liquid fusing agent based on an average of a number of drops of fusing agent). This could for example be applied to the shell at 1200 dpi in this example such that both the core and shell are defined at 600 dpi.

While the examples of 1200 dpi and 600 dpi are used herein, other resolutions (for example 300 dpi, 150 dpi or the like) may be used, or the resolution may be defined in some other way, for example with reference to the absolute sizes of the individual sub-volumes. In addition, while in the examples herein, a model is defined at two resolutions, but in other examples, there may be further defined resolutions.

In some examples, the sub-volumes at the common resolution are defined at an intended print resolution of the object (i.e. at an intended object generation apparatus print resolution).

Block 318 comprises applying halftoning to the object model sub-volumes associated with object generation parameters at the common resolution to determine print instructions for the layer. As will be familiar to the skilled person, halftoning can result in the selection of a particular print agent in a particular location. For example an object generation parameter may specify an area coverage or contone level for a print agent. A halftoning screen or algorithm may be used to make selections of locations and amounts of print agents to be placed to produce an intended result (which may be fusion of built material in a simple example, but which may comprise color, transparency, conductivity, density and the like in other examples), for example based on the area coverage. While halftoning is used in this example, in other examples, other techniques may be used. For example, if using piezo printheads, a drop volume could be directly specified. If the additive manufacturing technique is a selective laser sintering technique, the method may comprise specifying a power level of a laser. The control instructions may be generated at the higher (finer) resolution, for example at 1200 dpi in examples in which object generation parameters were defined at for the core at 600 dpi and at 1200 dpi for the shell.

In block 320, the value of i is incremented and, for as long as i is less than or equal to n (block 322), the method loops back to block 306. Once i is greater than n, all of the slices are processed and the method terminates in block 324.

In some examples, the method may comprise generating a layer using additive manufacturing based on print instructions generated in block 314 while the processing of data representing a further layer is carried out. In some examples, the time for processing data representing a layer is at least not substantially greater than the time for generating a layer using additive manufacturing based on print instructions. This means that the data processing and object generation may be readily interleaved, saving resources such as memory for storing the print instructions, while allowing for a consistent layer generation time, which may in turn lead to more consistent object generation results, as layers will not have cooled (or have to be kept warm) while the print instructions for a subsequent layer are prepared.

FIG. 4 shows an example of a method of generating an object comprising, in block 402, determining print instructions for a slice of an object model. Block 404 comprises at least starting generating the object layer corresponding to the object slice and block 406 comprises incrementing a slice index to proceed to the next slice. This therefore comprises an example of generating an object in a layer-by-layer manner, in which data processing and layer generation are interleaved.

In some examples, a few slices may be processed to provide at least one ‘buffer’ set of print instructions such that the processing of data leads the object generation by one or a few slices/layers.

By way of example, processing a layer at 600 dpi in an example virtual build volume using example processing resources may take around 6.5 seconds. This may be less than a layer generation time. If the entire slice of a virtual build volume was processed at 1200 dpi using the same resources, the processing time may increase to 30 seconds, which is considerably longer than the layer generation time. However, in an example in which the first depth was around 10 sub-volumes (voxels), the slice processing time may increase to around 7.5 seconds, which may be within the layer generation time.

FIG. 5 shows an apparatus 500 comprising processing circuitry 502. The processing circuitry 502 comprises an object segmentation module 504 and an object model adjustment module 506.

The object segmentation module 504, in use of the apparatus 500, segments a model of an object to be generated in three-dimensional object generation into a plurality of sub-volumes, each sub-volume representing a region of the object which is individually addressable in object generation. The object model sub-volumes within a first depth of an object model surface have a first size and object model sub-volumes beyond the first depth have a second size which is larger than the first size.

The object model adjustment module 506, in use of the apparatus 500, determines a geometrical adjustment to be made to the object model to compensate for changes to the geometry during manufacture thereof, and to apply at least one adjustment by adding or removing an object model sub-volume having the first size. To that end, the object model adjustment module 506 may perform heat analysis of object model data representing an object to be generated by an additive manufacturing apparatus to identify thermal effects such as a failure to fuse of a small feature, or a possible closing of a cavity or gap.

For example, the object model adjustment module 506 may scale or enlarge at least part of an object to account for an anticipated change in shape or an expected failure to fuse by adding object model sub-volumes. In some examples, the object model adjustment module 506 may remove or erode at least one object model sub-volume to prevent different object surfaces from fusing together. As described above, the object model adjustment module 506 is to add or remove the relatively small sub-volumes in the outer shell of an object model.

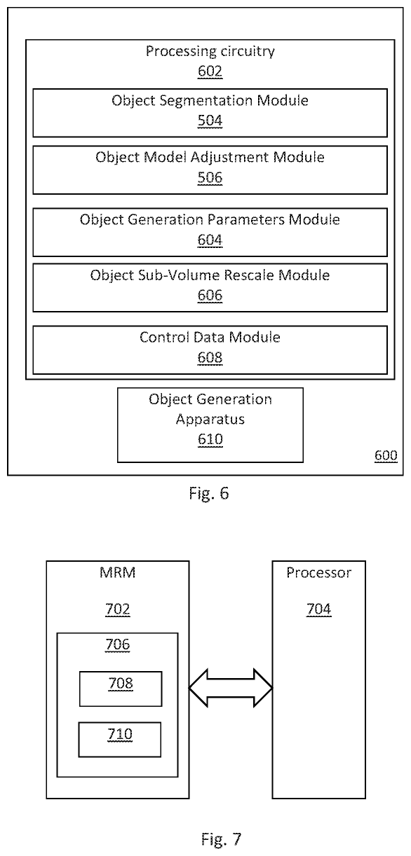

FIG. 6 shows an apparatus 600 comprising processing circuitry 602. The processing circuitry 602 comprises an object segmentation module 504 and an object model adjustment module 506 as described above in relation to FIG. 5.

In this example the processing circuitry 602 further comprises an object generation parameters module 604, an object sub-volume rescale module 606 and a control data module 608, and the apparatus 600 further comprises object generation apparatus 610.

In use of the apparatus 600, the object generation parameters module 604 associates object generation parameters with the object model sub-volumes of the first and second size. This may for example comprise specifying area coverage(s) for print agents such as fusing agents, colorants, detailing agents and the like. In some examples, other parameters, such as any, or any combination of heating temperatures, build material choices, a number of printing passes, an intent of the print mode, and the like, may be specified.

In use of the apparatus 600, the object sub-volume rescale module 606 rescales at least one of the object model sub-volumes of the first and second size having object generation parameters associated therewith. These sub-volumes may be rescaled to a common size. For example, this may comprise any or any combination of upscaling and downscaling the object model sub-volumes as discussed above.

In use of the apparatus 600, the control data module 608 generates control data to generate each of a plurality of layers of the object. This may for example comprise applying halftoning to specified object generation parameters.

The object generation apparatus 610, in use of the apparatus 600, generates the object in a plurality of layers (which may correspond to respective slices of a virtual build volume) according to the generated control data. The object generation apparatus 610 may for example generate an object in a layer-wise manner by selectively solidifying portions of layers of build materials. The selective solidification may in some examples be achieved by selectively applying print agents, for example through use of ‘inkjet’ liquid distribution technologies, and applying energy, for example heat, to the layer. The object generation apparatus 610 may comprise additional components not shown herein, for example a fabrication chamber, a print bed, print head(s) for distributing print agents, a build material distribution system for providing layers of build material, energy sources such as heat lamps and the like, which are not described in detail herein.

The processing circuitry 502, 602 or the modules thereof, may carry out any of the blocks of FIG. 1, FIG. 3 or 4.

FIG. 7 shows a machine readable medium 702 associated with a processor 704. The machine readable medium 702 comprises instructions 706 which, when executed by the processor 704, cause the processor 704 to carry out processes. The instructions 706 comprise instructions 708 to cause the processor 704 to determine from object model data for an object to be generated in additive manufacturing, a representation of a layer of the object as a plurality of print addressable volumes, wherein an outer shell of the layer is represented using smaller volumes than a core of the layer.

The instructions 706 further comprise instructions 710 to cause the processor 704 to add or remove at least one volume of the outer shell to correct for predicted dimensional deviation of object geometry during object generation.

In examples, the machine readable medium 702 may comprise instructions to carry out any, or any combination, of the blocks of FIG. 1, 3 or 4, or to act as part of the processing circuitry 502, 602 of FIG. 5 or 6.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus (such as the object segmentation module 504, the object model adjustment module 506, the object generation parameters module 604, the object sub-volume rescale module 606 and the control data module 608) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
acquiring, at a processor, a model of at least a portion of an object to be generated in three-dimensional object generation which is segmented into a plurality of object model sub-volumes, each sub-volume representing a region of the object which is individually addressable in object generation, wherein object model sub-volumes within a first depth of an object model surface are defined at a first resolution and object model sub-volumes beyond the first depth are defined at a second resolution, and the first resolution is a higher resolution than the second resolution;
applying, using a processor, an object generation model to the object model to determine at least one predicted dimensional deviation of the object in object generation; and
determining, using a processor, a geometric adjustment to the segmented object model to compensate for the predicted dimensional deviation by at least one of adding and removing at least one object model sub-volume defined at the first resolution.

2. A method according to claim 1 wherein applying the object generation model comprises applying a thermal object generation model to determine a predicted thermal mass.

3. A method according to claim 1 comprising segmenting the object model into a plurality of object model slices, and segmenting the object model into a plurality of sub-volumes on a slice by slice basis.

4. A method according to claim 1 further comprising associating object generation parameters with the object model sub-volumes.

5. A method according to claim 4 further comprising converting the object model sub-volumes associated with object generation parameters to a common resolution.

6. A method according to claim 4 in which converting the object model sub-volumes associated with object generation parameters to a common resolution comprises dividing at least one object model sub-volume into a plurality of smaller sub-volumes and associating object generation parameters of the divided sub-volume with each smaller sub-volume.

7. A method according to claim 4 further comprising applying halftoning to the object model sub-volumes associated with object generation parameters at the common resolution to determine print instructions.

8. A method according to claim 7 further comprising generating at least one slice of the object.

9. A method according to claim 1 comprising determining the first depth based on a predicted thermal mass of the object during object generation.

10. Apparatus comprising processing circuitry, the processing circuitry comprising:
an object segmentation module to segment a model of an object to be generated in three-dimensional object generation into a plurality of sub-volumes, each sub-volume representing a region of the object which is individually addressable in object generation, wherein object model sub-volumes within a first depth of an object model surface have a first size and object model sub-volumes beyond the first depth have a second size which is larger than the first size; and
an object model adjustment module to determine a geometrical adjustment to be made to the object model to compensate for changes to an object geometry during manufacture thereof, and to apply at least one adjustment by adding or removing an object model sub-volume having the first size.

11. Apparatus according to claim 10 further comprising an object generation parameters module to associate object generation parameters with the object model sub-volumes of the first and second size.

12. Apparatus according to claim 11 further comprising an object sub-volume rescale module to rescale at least one of the object model sub-volumes of the first and second size having object generation parameters associated therewith.

13. Apparatus according to claim 10 wherein the processing circuitry further comprises a control data module to generate control data to generate each of a plurality of layers of the object.

14. Apparatus according to claim 13 further comprising object generation apparatus to generate the object in a plurality of layers according to the generated control data.

15. A machine readable medium comprising instructions which when executed by a processor cause the processor to:
determine from object model data for an object to be generated in additive manufacturing, a representation of a layer of the object as a plurality of print addressable volumes, wherein an outer shell of the layer is represented using smaller volumes than a core of the layer; and
add or remove at least one volume of the outer shell to correct for predicted dimensional deviation of object geometry during object generation.
